(19) United States
(12) Patent Application Publication
(10) Pub. No.: US 2013/0233183 A1
(43) Pub. Date: Sep. 12, 2013

(54) COOKING APPARATUS AND SYSTEM

(71) Applicants: Amy Tinnell Brinckerhoff, Newton, MA (US); Eric Jennings, Boston, MA (US); Skinner Yiu, Shenzhen (CN); Ognjen Vrdoljak, Laval, CA (US); Allison Cummings, Boston, MA (US)

(72) Inventors: Amy Tinnell Brinckerhoff, Newton, MA (US); Eric Jennings, Boston, MA (US); Skinner Yiu, Shenzhen (CN); Ognjen Vrdoljak, Laval, CA (US); Allison Cummings, Boston, MA (US)

(73) Assignee: Euro-Pro Operating LLC, Newton, MA (US)

(21) Appl. No.: 13/261,659

(22) PCT Filed: Nov. 22, 2011
(86) PCT No.: PCT/US2011/061804

§ 371 Date: May 21, 2013

Related U.S. Application Data
(60) Provisional application No. 61/416,333, filed on Nov. 23, 2010.
(60) Provisional application No. 61/449,423, filed on Mar. 4, 2011.
(60) Provisional application No. 61/500,226, filed on Jun. 23, 2011.

(51) Int. Cl. A47J 37/12

(52) U.S. Cl. CPC A47J 37/12
USPC 99/403

(57) ABSTRACT

A cooking apparatus includes a container which defines four sides, a bottom and an open top. The cooking apparatus further includes a container handle which extends from a handle side of the four sides, and a cover which attaches to one of the four sides other than the handle side. The cover is constructed and arranged to transition between (i) an open position in which the cover substantially exposes the open top defined by the container to allow food product to enter or exit through the open top of the container and (ii) a closed position in which the cover substantially encloses the open top defined by the container to prevent food product from entering or exiting through the open top of the container.

### CROSS REFERENCE TO RELATED APPLICATIONS

This application claims the benefit under 35 U.S.C. §119(e) of U.S. Provisional Application Ser. No. 61/416,333 entitled “COOKING BASKET,” filed on Nov. 23, 2010, the contents and teachings of which are herein incorporated by reference in their entirety.

Additionally, this application claims the benefit under 35 U.S.C. §119(e) of U.S. Provisional Application Ser. No. 61/449,423 entitled “COOKING BASKET,” filed on Mar. 4, 2011, the contents and teachings of which are herein incorporated by reference in their entirety.

Furthermore, this application claims the benefit under 35 U.S.C. §119(e) of U.S. Provisional Application Ser. No. 61/500,226 entitled “HINGED BASKET,” filed on Jun. 23, 2011, the contents and teachings of which are herein incorporated by reference in their entirety.

### BACKGROUND

One conventional fry basket includes (i) a basket body and (ii) a basket handle which is connected to a wall of the basket body. An operator is able to place food into the basket body and then, while holding the basket handle, lower the basket body into a fryer filled with cooking oil in order to cook the food. Since the food may float in the cooking oil, the top rim of the basket body is purposefully made to extend above the height of the cooking oil to prevent the food from escaping from the basket body while the food floating in the cooking oil is being cooked.

Another conventional fry basket is similar to the above-described fry basket, but further includes a lid having (i) a lid body which further prevents food from escaping from the basket body and (ii) a lid handle to operate the lid body. The lid body attaches to the same basket body wall that is connected to the basket handle. Accordingly, the lid handle is able to mirror the contour of the basket handle thus enabling the operator to grasp both the basket handle and the lid handle with a single hand. To open the lid, the operator moves the lid handle relative to the basket handle in order to swing the lid body toward the basket handle and toward the operator.

### SUMMARY

An improved cooking apparatus includes a rectangular container and a cover which attaches to one of the four sides of the container other than the handle side. Such a cooking apparatus allows a user to open the cover in a direction other than toward the container handle and the user. For example, if the cover is configured to open toward the left, the user is able to hold the container handle with the right hand and conveniently open the cover toward the left side using the left hand. Similarly, if the cover is configured to open toward the right, the user is able to hold the container handle with the left hand and conveniently open the cover toward the right side using the right hand. Such configurations may provide users with improved comfort and control while maneuvering the cooking apparatus. Furthermore, such configurations prevent splattering of residual materials (e.g., hot cooking oil or other liquid medium) in the direction of the users.

One embodiment is directed to a cooking apparatus including a container which defines four sides, a bottom and an open top. The cooking apparatus further includes a container handle which extends from a handle side of the four sides, and a cover which attaches to one of the four sides other than the handle side. The cover is constructed and arranged to transition between (i) an open position in which the cover substantially exposes the open top defined by the container to allow food product to enter or exit through the open top of the container and (ii) a closed position in which the cover substantially encloses the open top defined by the container to prevent food product from entering or exiting through the open top of the container.

In some arrangements, the container and the cover are adapted to form a set of hinges on the left side and the right side at different times of operation. Such flexibility enables the user to customize the operation of the cooking apparatus for coordination and comfort based on whether the user is left-hand dominant or right-hand dominant.

In some arrangements, the cooking basket is further equipped with a latch to control movement of the cover from the closed position to the open position. In the arrangements in which the cover is able to selectively hinge from the right side and the left side, the same latch is able to control the cover regardless of whether the cover is currently hinged to the left side or to the right side.

In some arrangements, the cover is adapted to reside in a recessed location which is lower than the top edge of the container while in a closed position with respect to the container. Such a feature enables a top brim of the container to extend above the top surface of the cooking oil or other liquid medium while the cover maintains food product below the top surface (i.e., full immersion) for improved cooking rather than allow the food product to float at the surface. For example, since the food product is able to remain fully submerged, the food product may cook in a shorter period of time.

In some arrangements, the container includes container halves which are adapted to pivot relative to each other and relative to the container handle. Accordingly, while the user holds the container handle, the user is able to transition the container between (i) a retaining position in which the container halves are closed to prevent food product within the container from escaping through the bottom, and (ii) a bottom-emptying position in which the container halves separate to enable the food product within the container to escape through the bottom.

In some arrangements, the cooking apparatus is equipped with a trigger that enables the user to transition the container halves from the retaining position to the bottom-emptying position while the cover is in place. A depressible spring-biased button is suitable for use as the trigger.

Other embodiments are directed to cooking systems (e.g., personal or industrial fryer systems), other cooking devices and components, related cooking techniques, and so on. Some embodiments are directed to various processes for making and using the cooking apparatus.

It should be understood that the container may be made of stainless steel wire mesh or similar materials, and the food product may include potato, fish, chicken, among others. In some instances, the food product may be breaded or battered with flour or other types of coatings.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a perspective view of a cooking system which includes a first version of a cooking apparatus having a side-hinged cover in a closed position.

FIG. 2 is a perspective view of the first version of the cooking apparatus while the cover is hinged to a right side and the cover is in an opened position.

FIG. 3 is a top view of the first version of the cooking apparatus while the cover is hinged to the right side and the cover is in the closed position.

FIG. 4 is a front view of the first version of the cooking apparatus while the cover is hinged to the right side and the cover is in the closed position.

FIG. 5 is a perspective view of the first version of the cooking apparatus while the cover is hinged to the left side and the cover is in the closed position.

FIG. 6 is a top view of the first version of the cooking apparatus while the cover is hinged to the left side and the cover is in the closed position.

FIG. 7 is a front view of the first version of the cooking apparatus while the cover is hinged to the left side and the cover is in the closed position.

FIG. 8 is a perspective view of a second version of the cooking apparatus having a side-hinged cover and a bottom-emptying container.

FIG. 9 is a detailed perspective view of a trigger of the second version of the cooking apparatus when the trigger is in a non-actuated state.

FIG. 10 is a detailed perspective view of the trigger of the second version of the cooking apparatus when the trigger is in an actuated state.

FIG. 11 is a perspective view of the second version of the cooking apparatus when the trigger is in an actuated state.

FIG. 12 is a detailed perspective view of a third version of the cooking apparatus having a side-hinged cover in a closed position.

FIG. 13 is a detailed perspective view of the third version of the cooking apparatus having the side-hinged hinged cover in an opened position.

### DETAILED DESCRIPTION

An improved cooking apparatus includes a rectangular container and a cover which attaches to one of the four sides of the container other than the handle side. Such a cooking apparatus allows a user to open the cover in a direction other than toward the container handle and toward the user. For example, if the cover is configured to open toward the left, the user is able to hold the container handle with his or her right hand and conveniently open the cover toward the left side using his or her left hand. Similarly, if the cover is configured to open toward the right, the user is able to hold the container handle with his or her left hand and conveniently open the cover toward the right side using his or her right hand. Such configurations may provide users with improved comfort and control while maneuvering the cooking apparatus. Moreover, such configurations may prevent splattering of residual materials (e.g., hot cooking oil or another liquid medium) in the user's direction.

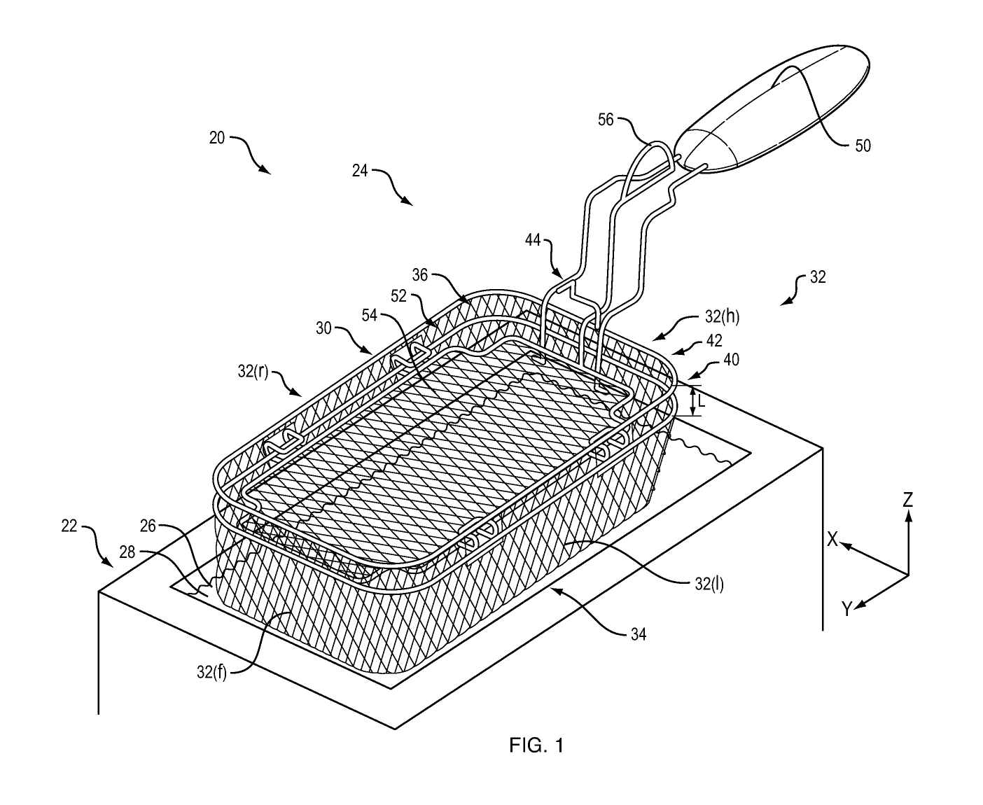

FIG. 1 shows an improved cooking system 20 for cooking food products. The cooking system 20 includes a fryer device 22 and a cooking apparatus 24. The fryer device 22 defines a cavity 26 to hold and heat cooking oil (or other liquid medium) 28. The fryer device 22 may sit safely on a flat surface (e.g., a table, a floor, etc.) and thus allow the user to effectively maneuver the cooking apparatus 24 relative to the fryer device 22 at a convenient height (e.g., waist level, counter level, etc.).

The cooking apparatus 24 includes a rectangular container 30 which defines a front side 32(f), a handle side 32(h), a right side 32(r), and a left side 32(l) (collectively, sides 32), a bottom 34 and an open top 36. The right side 32(r) (as viewed from the handle side 32(h) of the cooking apparatus 24) extends from a right edge of the handle side 32(h) to a right edge of the front side 32(f). Similarly, the left side 32(l) extends from a left edge of the handle side 32(h) to a left edge of the front side 32(f). Accordingly, the right and left sides 32(r), 32(l) are opposite each other and extend in a parallel manner in Y-Z planes. Likewise, the front and handle sides 32(f), 32(h) are opposite each other and extend in a parallel manner in X-Z planes. Furthermore, the bottom 34 and the open top 36 are opposite each other and extend in a parallel manner in X-Y planes. In some arrangements, some of the side and bottom edges are rounded.

As shown in FIG. 1, the sides 32 and bottom 34 of the container 30 are porous to enable the cooking oil 28 to enter the container 30 when the container 30 is lowered into the cavity 26 defined by the fryer device 22. Such porosity further allows the cooking oil 28 to drain from the container 30 when the container 30 is removed from the cavity 26 defined by the fryer device 22.

In some arrangements, the sides 32 and bottom 34 are made of a stainless steel material in the form of wire mesh. In these arrangements, the container 30 includes a recessed set of railing segments 40 (i.e., one or more recessed railing segments 40), a top set of railing segments 42 (i.e., one or more top railing segments 42), and a latch 44. The railing segments 40, 42 provide strength to container 30 as well as aid in defining the container's shape. The recessed railing segments 40 are recessed (or offset) from the top railing segments 42 (and thus from the top opening 36) by a predefined length L (e.g., 0.5 inches, 0.75 inches, 1.0 inches, etc.).

The cooking apparatus 24 further includes a container handle 50 which extends from the handle side 32(h), and a cover 52 which attaches to one of the four sides 32 other than the handle side 32(h). The cover 52 includes a basket wall portion 54 and a gripping portion 56 which extends from the basket wall portion 54.

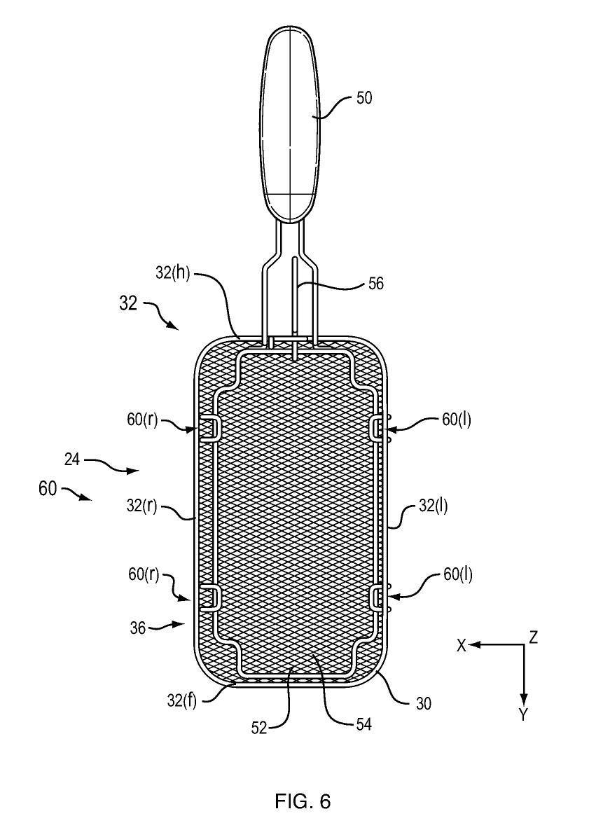

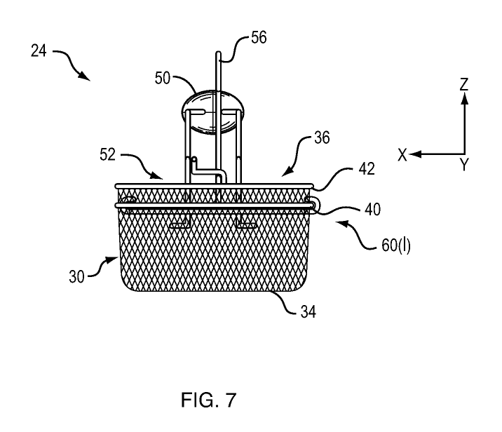

During operation, the cover 52 is capable of hinging to both the right side 32(r) and the left side 32(l) of the container 30 at different times. Such operation provides the user with flexibility and customizability in that the user can adjust the cover 52 to hinge on a side of greatest comfort or to accommodate a particular situation. Furthermore, the latch 44 is capable of controlling locking and unlocking of the cover 52 relative to the container 30. Further details will now be provided with reference to FIGS. 1-7.

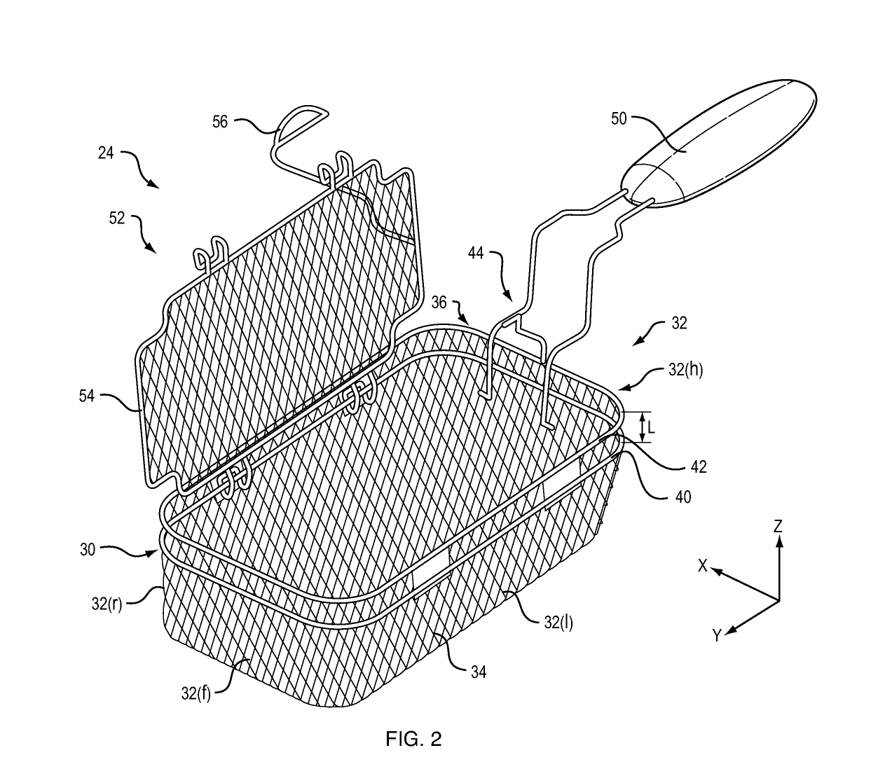

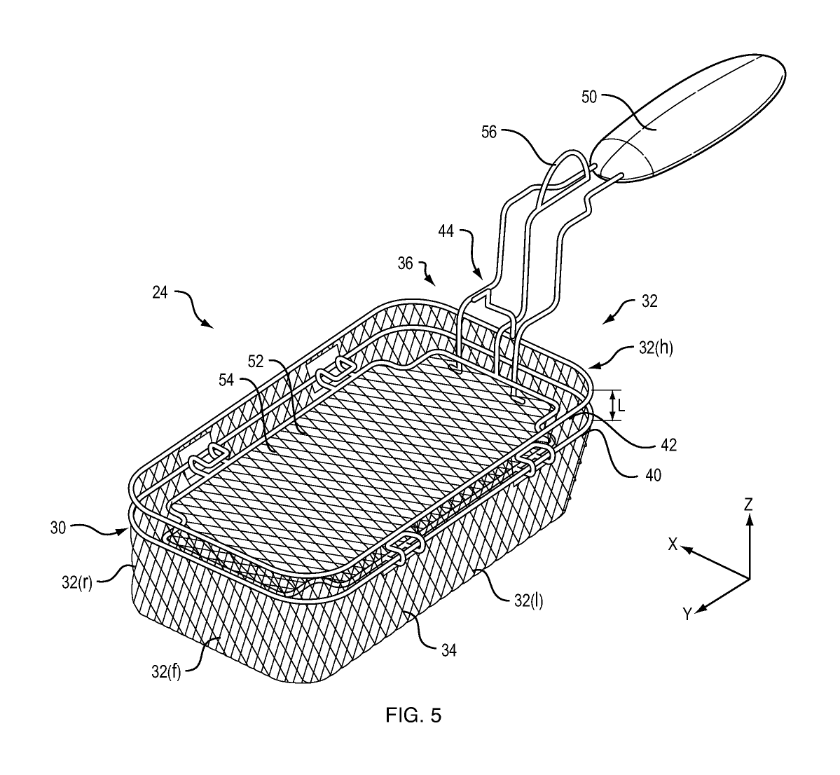

FIGS. 2-7 show further details of the cooking apparatus 24. In particular, FIGS. 2-4 show the cooking apparatus 24 when the cover 52 attaches to the right side 32(r) of the container 30 (also see FIG. 1). Additionally, FIGS. 5-7 show the cooking apparatus 24 when the cover 52 attaches to the left side 32(l) of the container 30.

Turning to FIGS. 1 and 2, it should be understood that the cover 52 is constructed and arranged to pivot relative to the container 30. FIG. 1 shows the cooking apparatus 24 when the cover 52 is in a closed position, i.e., when the basket wall portion 54 of the cover 52 substantially encloses the open top 36 defined by the container 30 to prevent food product from entering or exiting through the open top 36 of the container 30. Here, the latch 44 secures the cover 52 in place (e.g., by providing interference) to prevent inadvertent opening of the cover 52.

In contrast, FIG. 2 shows the cooking apparatus 24 when the cover 52 is in the open position, i.e., when the cover 52 substantially exposes the open top 36 defined by the container 30 to allow food product to enter or exit through the open top 36 of the container 30. Here, the user has transitioned the latch 44 from a latched state to an unlatched state (e.g., turned the latch 44, deflected the gripping portion 56, etc. so that the cover 52 is no longer secured in the closed position). The user has then pivoted the cover 52 (e.g., by providing arc movement to the gripping portion 56) to move the cover 52 to the open position.

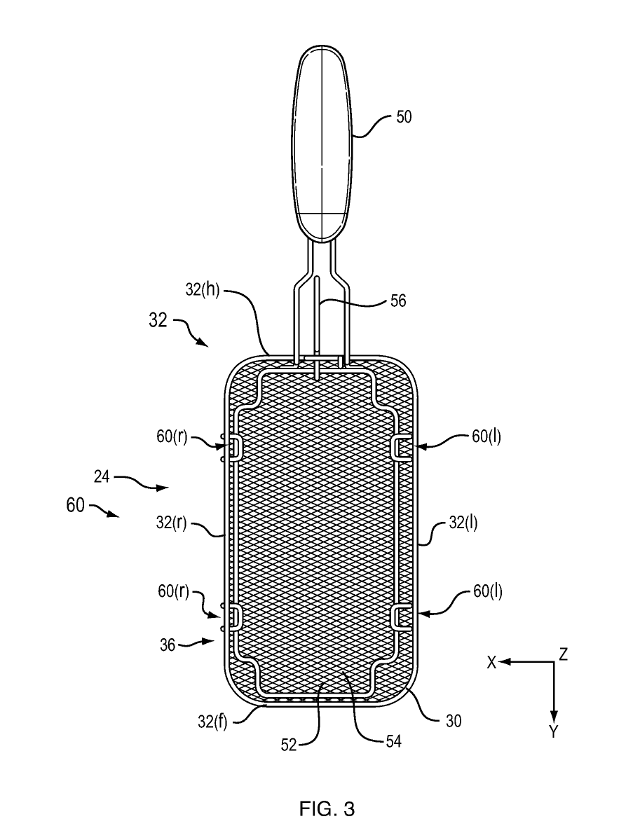

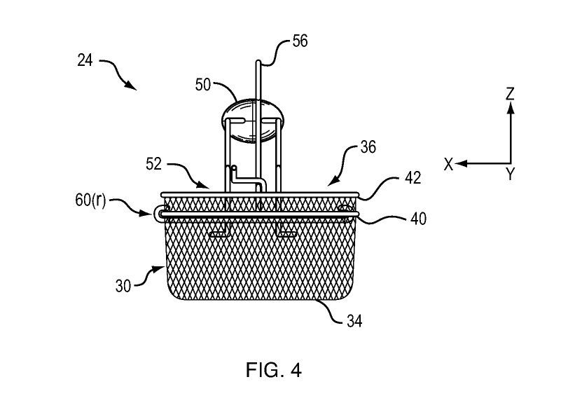

Turning to FIGS. 3-4, the cover 52 hinges with the recessed set of railing segments 40 of the container 30. By way of example only, FIGS. 3-4 show the cover 52 hinging on a recessed railing segment 40 on the right side 32(r) of the container 30. Accordingly, the cover 52 is able to enclose the top opening 36 while positioning the food products fully beneath the surface of the cooking oil 28 for full immersion cooking (also see FIG. 1).

In some arrangements, the cover 52 includes a set of hooks 60 which form hinges with the recessed set of railing segments 40. In particular, the set of hooks 60 includes a pair of hooks 60(r) on the right edge of the basket wall portion 54, and another pair of hooks 60(l) on the left edge of the basket wall portion 54. Accordingly, the cover 52 is able to form a set of right side hinges on the right side 32(r) of the container 30 and a set of left side hinges on the left side 32(l) of the container 30 while the gripping portion 56 remains adjacent the latch 44 and the container handle 50.

Turning to FIGS. 5-7, the user is able to conveniently switch the cover 52 so that the cover 52 hinges from the other side 32 of the container 30. For example, to switch the cover 52 from the right side 32(r) to the left side 32(l), the user simply disengages the hooks 60(r) on the right edge of the basket wall portion 54 from the right side 32(r) of the container 30, and engages the hooks 60(l) on the left edge of the basket wall portion 54 on the left side 32(l) of the container 30.

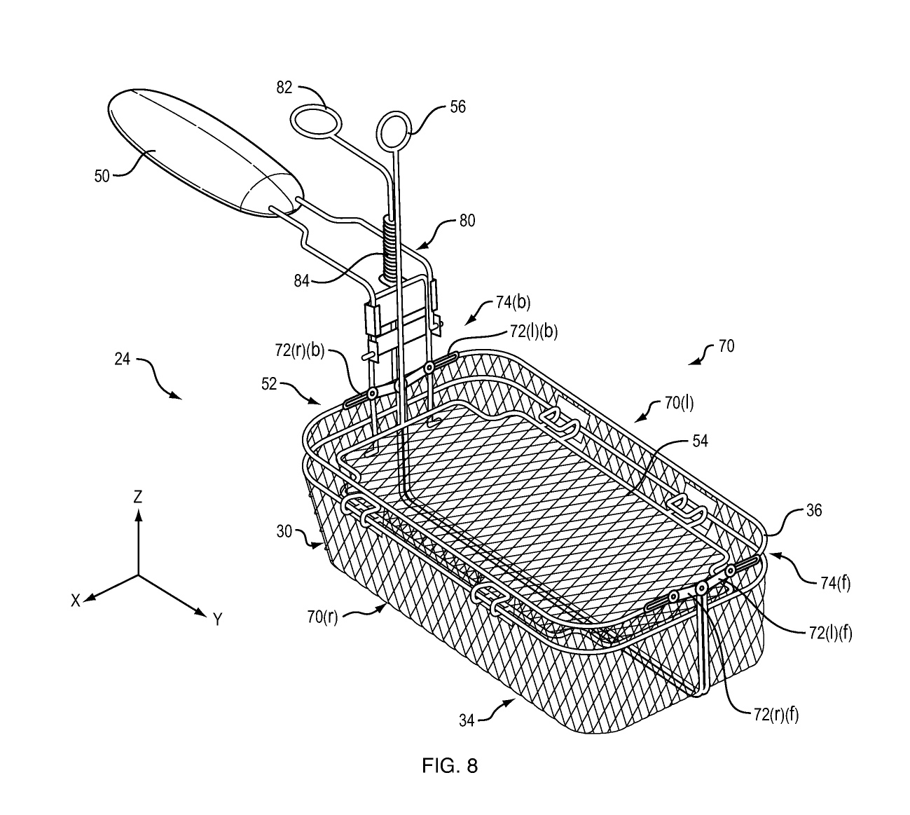

It should be understood that when the cover 52 is attached to the opposite side of the container 30 (e.g., the right side 32(l)), the operation of the cooking apparatus 24 is substantially the same. That is, the cover 52 is able to enclose the top opening 36 while positioning the food products fully beneath the surface of the cooking oil 28 for full immersion cooking. Furthermore, the gripping portion 56 remains adjacent the latch 44 and the container handle 50 and, when the user unlatches the cover 52, the user is able to apply arc movement to the gripping portion 56 to move the cover 52 from the closed position to the open position. Further details will now be provided with reference to FIGS. 8-11.

FIGS. 8-11 show another version of the cooking apparatus 24. In contrast to the version shown in FIGS. 1-7 in which the bottom 34 of the container 30 did not open, the version of FIGS. 8-11 allows the bottom 34 to open. To this end, the container 30 includes a left container half 70(l) and a right container half 70(r) (collectively, container halves 70) which are constructed and arranged to pivot relative to each other and relative to the container handle 50. In particular, the left container half 70(l) includes a left-front hinge member 72(l)(f) and a left-back hinge member 72(l)(b). Likewise, the right container half 70(r) includes a right-front hinge member 72(r)(f) and a right-back hinge member 72(r)(b). The left-front hinge member 72(l)(f) and the right-front hinge member 72(r)(f) form a front hinge 74(f). Similarly, the left-back hinge member 72(l)(b) and the right-back hinge member 72(r)(b) form a back hinge 74(b).

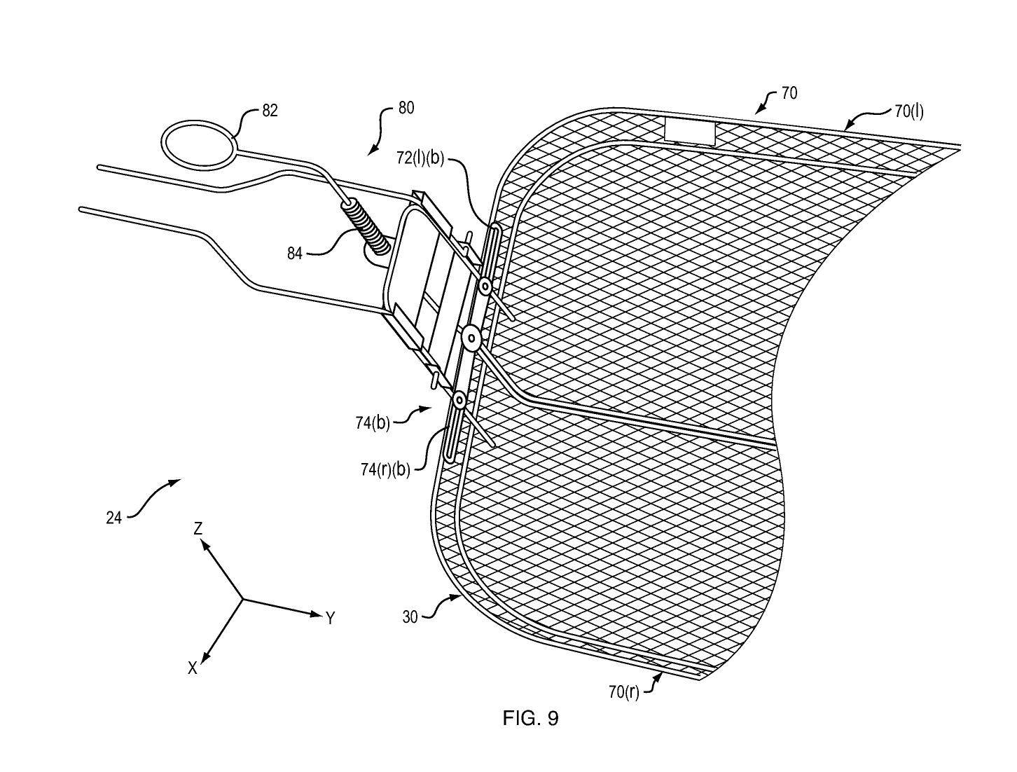

FIG. 8 shows the container halves 70 in a retaining position which prevents the food product from escaping through the bottom 34. That is, the container 30 includes two opposed wire mesh halves which integrally form the bottom 34 and a hold area for food product when brought together. FIG. 9 shows particular details of a trigger 80 of the cooking apparatus 24 which is constructed and arranged to transition the container halves 70 from the retaining position to a bottom-emptying position. In particular, the trigger 80 includes a button portion 82 (e.g., a metallic loop sized for actuation by a human thumb) and a spring 84 which biases the container halves 70 toward each other to maintain the container halves 70 in the retaining-position.

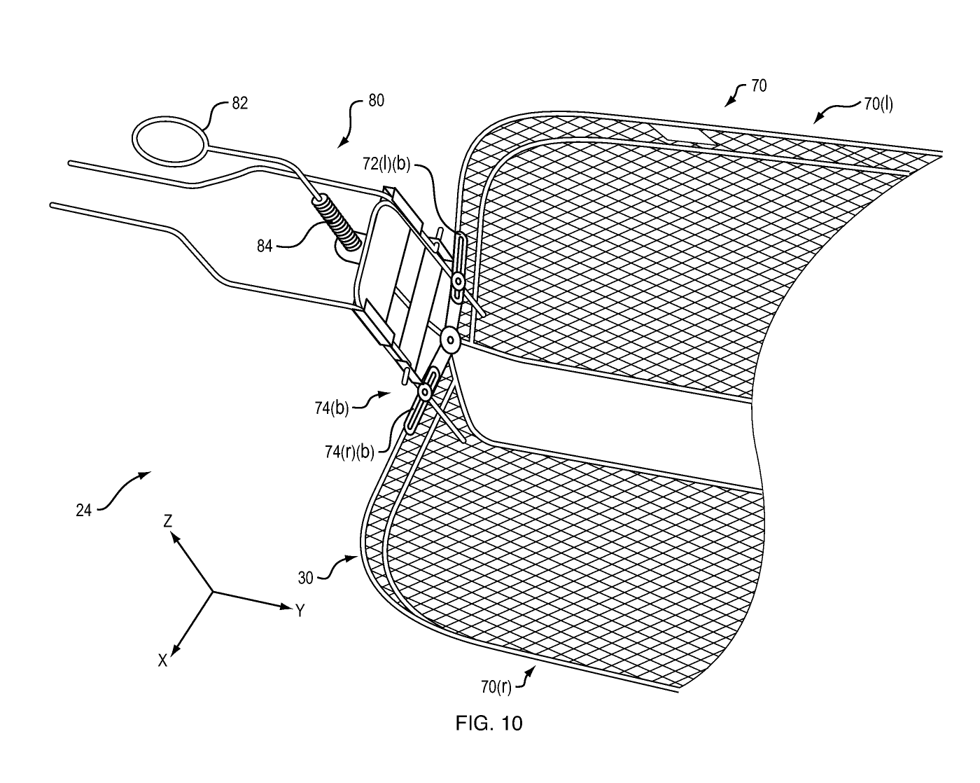

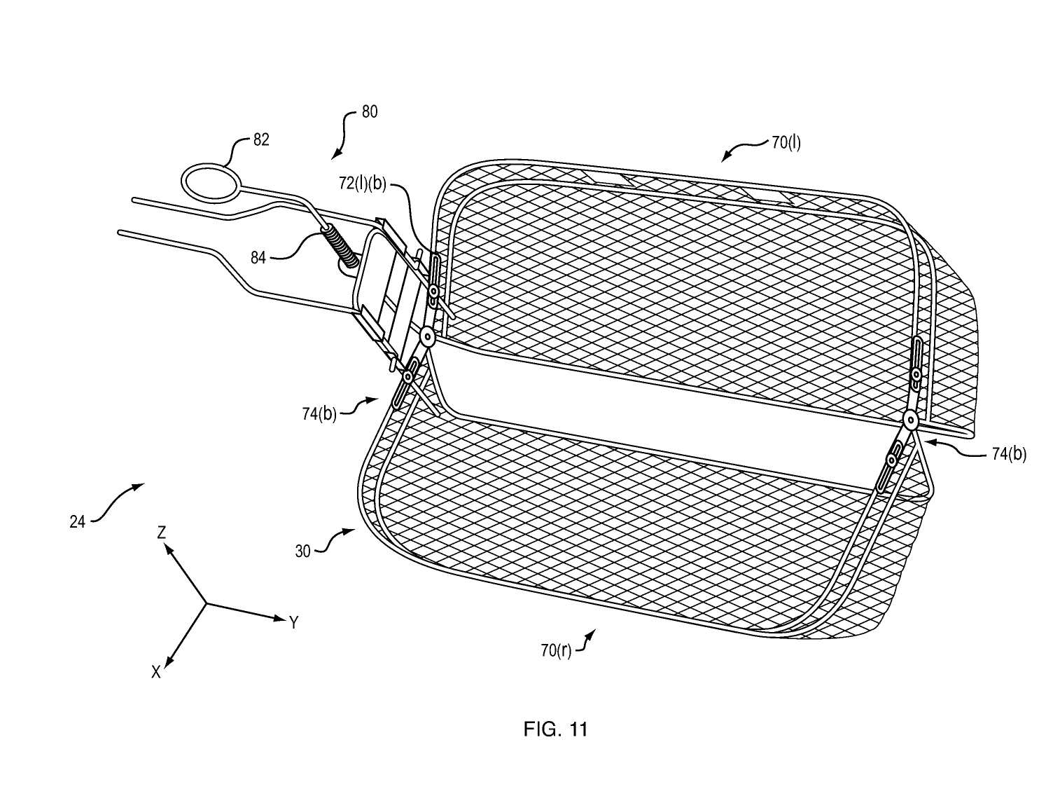

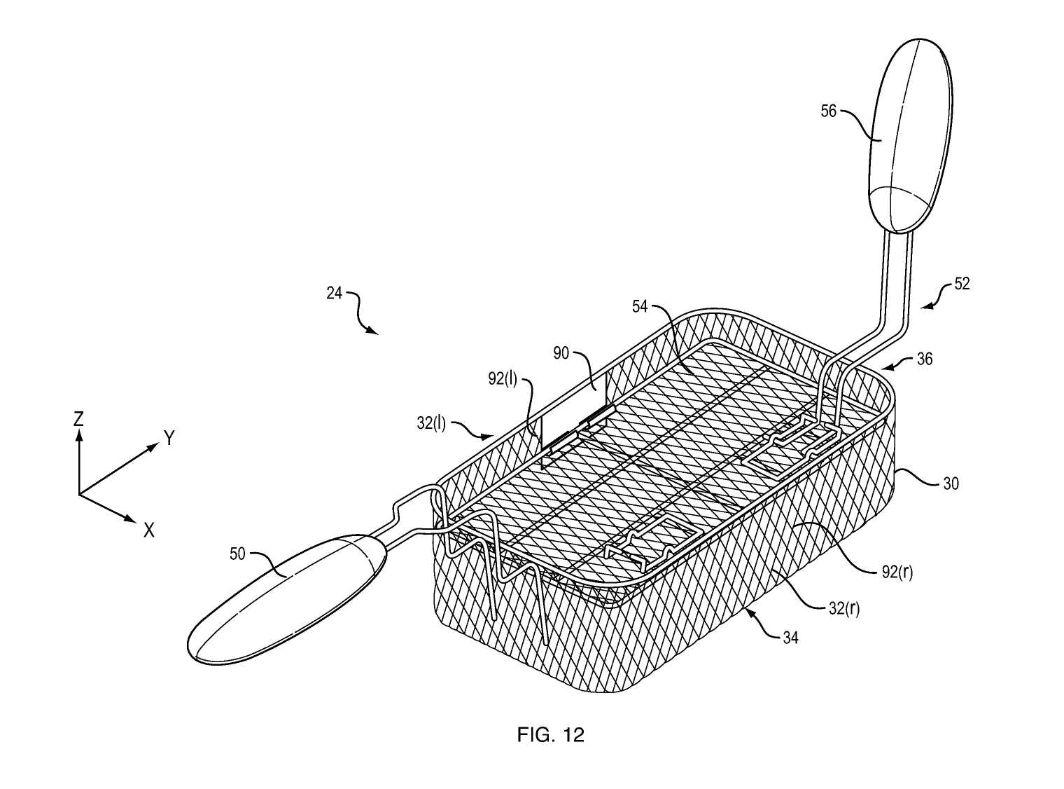

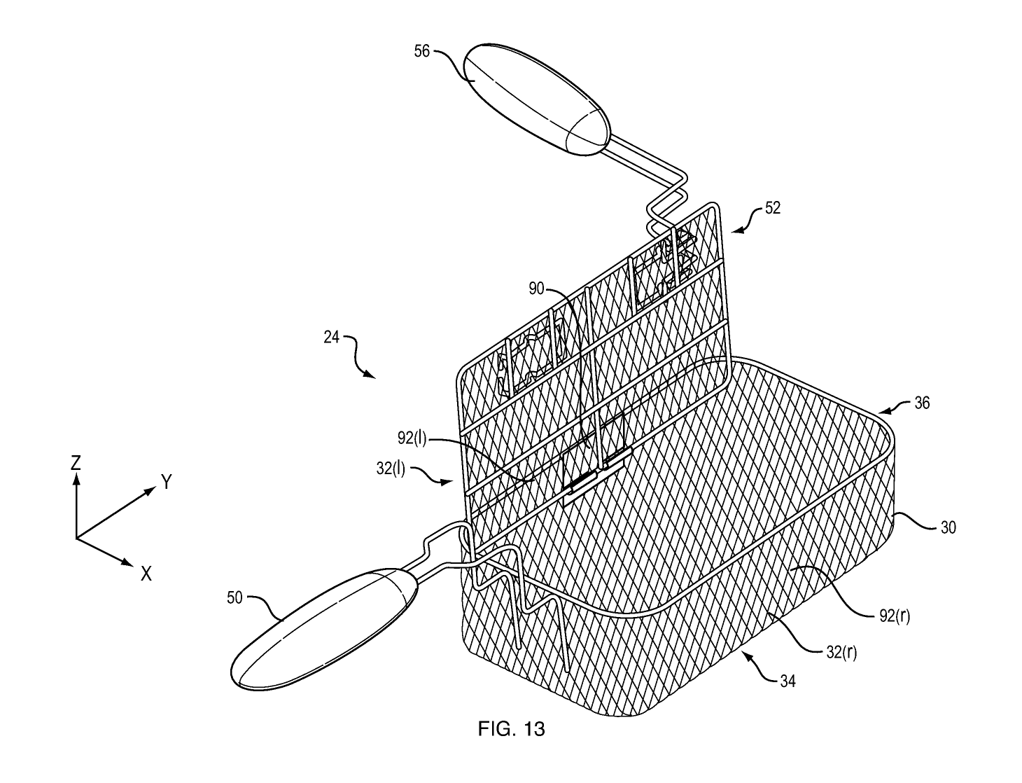

As shown in FIGS. 10 and 11, when the user actuates the trigger 80 by depressing the button portion 82 in the downward direction (i.e., the negative Z-direction) to overcome the biasing force of the spring 84, the trigger 80 directs the container halves 70 to pivot relative to each other about a pivot axis in the Y-direction and into the bottom-emptying position. Accordingly, any food product in the container 30 is allowed to escape through the bottom 34 (see FIG. 11). In some arrangements, the button portion 82 is positioned adjacent container handle 50 to enable the user to simultaneously hold the container handle 50 and actuate the trigger 82 using the same hand. In some arrangements, the various components of the cooking apparatus 24 are geometried so that the user is able to actuate the trigger 82 and open the bottom 34 of the container 30 even when the cover 52 is in the closed position. Further details will now be provided with reference to FIGS. 12 and 13.

FIGS. 12 and 13 show a third version of the cooking apparatus 24 which is similar to the first version in FIGS. 1-7 and the second version in FIGS. 8-11. However, in the third version of FIGS. 12 and 13, the cover 52 attaches to the sides 32 of the container 30 via friction hinges 90. By way of example, FIGS. 12 and 13 show the cover 52 hinged to the left side 32(l) of the container 30 at a location 92(l) via a single friction hinge 90. However, it should be understood that the cover 52 can be removed at the location 92(l) and attached to the right side 32(r) of the container 30 at a location 92(r).

The friction hinge 90 allows the cover 52 to remain in the closed position (FIG. 12) without need of any latch 44 (e.g., see FIG. 1). Furthermore, the friction hinge 90 allows the cover 52 to remain in the open position (see FIG. 13) or at any intermediate opening angle without the user needing to hold the cover 52.

Additionally, by way of example, only, the gripping portion 56 of the cover 52 is shown adjacent the front side 32(f) of the container. Although such an arrangement is achievable in any of the cooking apparatus versions, placement of the gripping portion 56 away from the container handle 30 is more easily achieved in this third version since the friction hinge 90 alleviates the need for a cover latch. In some arrangements, the gripping portion 56 is capable of pivoting relative to the basket wall portion 54 via tab clips (e.g., see FIGS. 12 and 13). Moreover, in these arrangements, the user is able to switch the points of attachment of the gripping portion 56 to various locations of the basket wall portion 54 via the tab clips for added flexibility.

As mentioned above, an improved cooking apparatus 24 includes a rectangular container 30 and a cover 52 which attaches to one of the four sides 32 of the container 30 other than the handle side 32(h). Such a cooking apparatus allows a user to open the cover 52 in a direction other than toward the container handle 32(h) and the user. For example, if the cover 52 is configured to open toward the left, the user is able to hold the container handle 50 with the right hand and conveniently open the cover toward the left side using the left hand. Similarly, if the cover 52 is configured to open toward the right, the user is able to hold the container handle 50 with the left hand and conveniently open the cover 52 toward the right side using the right hand. Such configurations may provide users with improved comfort and control while maneuvering the cooking apparatus 24. Furthermore, such configurations prevent splattering of residual materials (e.g., hot cooking oil or other liquid medium 28) in the direction of the users.

While various embodiments of the invention have been particularly shown and described, it will be understood by those skilled in the art that various changes in form and details may be made therein without departing from the spirit and scope of the invention as defined by the appended claims.

For example, it should be understood that the cover 52 was described above as attaching to the container 30 via hook-style hinges (e.g., hooks, hook and loop fasteners, etc.) or via friction hinges. Other types of hinges are suitable for use as well such as barrel hinges, spring hinges, magnetic hinges, and so on.

Additionally, the container 30 was described above as being formed primarily of a wire mesh structure by way of example only. In other arrangements, the container 30 is constructed of a stainless steel material in the form of a solid basket, or a perforated basket. Likewise, the basket wall portion 54 of the cover 52 can be constructed of similar stainless steel material.

Furthermore, the container 30 was described above as having two sets of railing segments 40, 42 running in parallel by way of example only. In other arrangements, the container 30 includes a different number of sets of railing segments (e.g., one, three, four, etc.). One of skill in the art will appreciate that such similarly shape railings can be positioned at different heights to provide different full immersion effects when cooking various food products. Such modifications and enhancements are intended to belong to various embodiments of the invention.

What is claimed is:

1. Cooking apparatus, comprising:
a container which defines four sides, a bottom and an open top;
a container handle which extends from a handle side of the four sides; and
a cover which attaches to one of the four sides other than the handle side, the cover being constructed and arranged to transition between (i) an open position in which the cover substantially exposes the open top defined by the container to allow food product to enter or exit through the open top of the container and (ii) a closed position in which the cover substantially encloses the open top defined by the container to prevent food product from entering or exiting through the open top of the container.

2. Cooking apparatus as in claim 1 wherein, when the cover attaches to one of the four sides other than the handle side, the cover is able to pivot relative to that one of the four sides other than the handle side.

3. Cooking apparatus as in claim 2 wherein, in addition to the handle side, the four sides of the container include:
a front side which is opposite the handle side,
a left side which extends from a left edge of the front side to a left edge of the handle side, and
a right side which extends from a right edge of the front side to a right edge of the handle side, the right side being opposite the left side; and
wherein at least one of the left side and the right side of the container is constructed and arranged to form a hinge with the cover.

4. Cooking apparatus as in claim 3 wherein the cover includes:
a basket wall portion which, when the cover is in the closed position, is substantially coplanar with the bottom of the container, and
a gripping portion coupled to and extending from the basket wall portion, the gripping portion being constructed and arranged to receive arc movement from a user to pivot the cover between the closed position and the open position.

5. Cooking apparatus as in claim 4 wherein the container includes:
a latch which is constructed and arranged to move between (i) a latched state in which the latch interferes with the gripping portion of the cover to maintain the cover in the closed position and (ii) an unlatched state in which the latch allows the gripping portion of the cover to move in response to the arc movement from the user to enable the cover to move from the closed position to the open position.

6. Cooking apparatus as in claim 3 wherein both the left side and the right side of the container are constructed and arranged to form, at different times, a hinge with the cover.

7. Cooking apparatus as in claim 6 wherein the left side of the container includes a set of left-side hooking regions to form a set of left-side hinges with the cover when the cover engages the set of left-side hooking regions; and
wherein the right side of the container includes a set of right-side hooking regions to form a set of right-side hinges with the cover when the cover engages the set of right-side hooking regions.

8. Cooking apparatus as in claim 7 wherein the cover includes:
a basket wall portion which, when the cover is in the closed position, is substantially coplanar with the bottom of the container,
a pair of left-side hooks coupled to a left edge of the basket wall portion, the pair of left-side hooks being constructed and arranged to attach to the set of left-side hooking regions when the cover engages the set of left-side hooking regions, and
a pair of right-side hooks coupled to a right edge of the basket wall portion which is opposite the left edge of the basket wall portion, the pair of right-side hooks being constructed and arranged to attach to the set of right-side hooking regions when the cover engages the set of right-side hooking regions.

9. Cooking apparatus as in claim 7 wherein the container includes:
a recessed set of railing segments, the pair of left-side hooks of the cover being constructed and arranged to engage a left-side railing segment of the recessed set of railing segments, and the pair of right-side hooks of the cover being constructed and arranged to engage a right-side railing segment of the recessed set of railing segments.

10. Cooking apparatus as in claim 9 wherein the container further includes:
a top edge set of railing segments which defines the open top, the top edge set of railing segments running along side the recessed set of railing segments in a substantially parallel manner.

11. Cooking apparatus as in claim 3 wherein the container includes a left container half and a right container half, which are constructed and arranged to pivot relative to each other and relative to the container handle.

12. Cooking apparatus as in claim 11 wherein, when the left container half and the right container half pivot to a bottom-emptying position, a bottom portion of the left container half and a bottom portion of the right container half move away from each other to enable food product within the container to escape between the bottom portions.

13. Cooking apparatus as in claim 11 wherein, when the left container half and the right container half pivot to a retaining position, a bottom portion of the left container half and a bottom portion of the right container half move toward each other to prevent food product within the container from escaping between the bottom portions.

14. Cooking apparatus as in claim 11 wherein, when the left container half and the right container half pivot to a bottom-emptying position, a bottom portion of the left container half and a bottom portion of the right container half move away from each other to enable food product within the container to escape between the bottom portions of the left and right container halves;
wherein, when the left container half and the right container half pivot to a retaining position, a bottom portion of the left container half and a bottom portion of the right container half move toward each other to prevent food product within the container from escaping between the bottom portions of the left and right container halves; and
wherein the cooking apparatus further comprises a trigger which is constructed and arranged to transition the left container half and the right container half between the retaining position and the bottom-emptying position in response to user actuation.

15. Cooking apparatus as in claim 11 wherein the left container half includes a left-front hinge member and a left-back hinge member;
wherein the right container half includes a right-front hinge member and a right-back hinge member;
wherein the left-front hinge member of the left container half and the right-front hinge member of the right container half form a front hinge on the front side; and
wherein the left-back hinge member of the left container half and the right-back hinge member of the right container half form a back hinge on the back side, the front hinge and the back hinge being constructed and arranged to control pivoting movement of the left container half and the right container half relative to each other.

16. Cooking system, comprising:
a fryer unit defining a cavity; and
a cooking apparatus constructed and arranged to position food product within the cavity defined by the fryer unit, the cooking apparatus including:
a container which defines four sides, a bottom and an open top,
a container handle which extends from a handle side of the four sides, and
a cover which attaches to one of the four sides other than the handle side, the cover being constructed and arranged to transition between (i) an open position in which the cover substantially exposes the open top defined by the container to allow the food product to enter or exit through the open top of the container and (ii) a closed position in which the cover substantially encloses the open top defined by the container to prevent the food product from entering or exiting through the open top of the container.

17. Cooking system as in claim 16 wherein, when the cover of the cooking apparatus attaches to one of the four sides other than the handle side, the cover is able to pivot relative to that one of the four sides other than the handle side.

18. Cooking system as in claim 17 wherein, in addition to the handle side, the four sides of the container of the cooking apparatus include:
a front side which is opposite the handle side,
a left side which extends from a left edge of the front side to a left edge of the handle side, and
a right side which extends from a right edge of the front side to a right edge of the handle side, the right side being opposite the left side; and
wherein at least one of the left side and the right side of the container is constructed and arranged to form a hinge with the cover.

19. Cooking system as in claim 18 wherein the cover of the cooking apparatus includes:
a basket wall portion which, when the cover is in the closed position, is substantially coplanar with the bottom of the container, and
a gripping portion coupled to and extending from the basket wall portion, the gripping portion being constructed and arranged to receive arc movement from a user to pivot the cover between the closed position and the open position; and
wherein the container includes:
a latch which is constructed and arranged to move between (i) a latched position in which the latch interferes with the gripping portion of the cover to maintain the cover in the closed position and (ii) an unlatched position in which the latch allows the gripping portion of the cover to move in response to the arc movement from the user to enable the cover to move from the closed position to the open position.

20. Cooking system as in claim 19 wherein both the left side and the right side of the container of the cooking apparatus are constructed and arranged to form, at different times, a hinge with the cover of the cooking apparatus.
